(19) United States
(12) Patent Application Publication
(10) Pub. No.: US 2006/0251872 A1
(43) Pub. Date: Nov. 9, 2006

(54) Conductive barrier layer, especially an alloy of ruthenium and tantalum and sputter deposition thereof

(76) Inventors: Jenn Yue Wang, Fremont, CA (US); Wei D. Wang, San Jose, CA (US); Ronjun Wang, Cupertino, CA (US); Yoichiro Tanaka, San Jose, CA (US); Hua Chung, San Jose, CA (US); Hong Zhang, Fremont, CA (US); Jick Yu, San Jose, CA (US); Praburam Gopalraja, San Jose, CA (US); Jianming Fu, Palo Alto, CA (US)

Correspondence Address: LAW OFFICES OF CHARLES GUENZER;ATTN: APPLIED MATERIALS, INC., 2211 PARK BOULEVARD, P.O. BOX 60729, PALO ALTO, CA, 94306, US

(21) Appl. No.: 11/124,611

(22) Filed: May 5, 2005

(51) Int. Cl. B32B 3/00

(52) U.S. Cl. 428/209

(57) ABSTRACT

A fabrication method, a product structure, a fabrication method, and a sputtering target for the deposition of a conductive barrier or other liner layer in an interconnect structure. The barrier layer comprises a conductive metal of a refractory noble metal alloy, such as a ruthenium/tantalum alloy, which may be amorphous though it is not required to be so. The barrier layer may be sputtered from a target of similar composition. The barrier and target composition may be chosen from a combination of the refractory metals and the platinum-group metals as well as RuTa. A copper noble seed layer may be formed of an alloy of copper and ruthenium in contact to a barrier layer over the dielectric.

### FIELD OF THE INVENTION

The invention relates generally to electrical interconnects including a barrier layer in semiconductor integrated circuits. In particular the invention relates to conductive metal barriers that are not subject to oxidation, such as amorphous metal barriers, or are conductive when oxidized and their sputter deposition.

### BACKGROUND ART

Sputtering, alternatively called physical vapor deposition (PVD), is the most prevalent method of depositing layers of metals and related materials in the fabrication of silicon integrated circuits. One challenging application in the fabrication of advanced integrated circuits is to sputter deposit thin liner layers in vertical electrical interconnects, usually called vias, for copper metallization. A conventional magnetron sputter reactor 10, illustrated schematically in cross section in FIG. 1, with different targets can effectively sputter thin films of Cu, Ta, TaN, and other materials into holes having high aspect ratios and can further act to plasma clean the substrate. The reactor 10 includes a vacuum chamber 12 arranged generally symmetrically about a central axis 14. A vacuum pump system 16 pumps the chamber 12 to a very low base pressure in the range of 10⁻⁶ Torr. However, a gas source 18 connected to the chamber through a mass flow controller 20 supplies argon as a sputter working gas. The argon pressure inside the chamber 12 is typically held in the low milliTorr range. A second gas source 22 supplies nitrogen gas into the chamber through another mass flow controller 24 when a metal nitride is being deposited.

A pedestal 30 arranged about the central axis 14 holds a wafer 32 or other substrate to be sputter coated. An unillustrated clamp ring or electrostatic chuck may be used to hold the wafer 32 to the pedestal 30. An RF power supply 34 is connected through a capacitive coupling circuit 36 to the pedestal 30, which is conductive and acts as an electrode. In the presence of a plasma, the capacitively RF biased pedestal 30 develops a negative DC self-bias, which effectively attracts and accelerates positive ions in the plasma. An electrically grounded shield 36 protects the chamber walls and the sides of the pedestal 30 from sputter deposition. A target 38 of the chosen deposition material is arranged in opposition to the pedestal 30 and is vacuum sealed to but electrically isolated from the chamber 12 through an isolator 40. At least the front surface of the target 38 is composed of a metallic material to be deposited on the wafer 32, which for the conventional liner materials is either copper or tantalum.

A DC power supply 42 electrically biases the target 38 with respect to the grounded shield 36 to cause the argon to discharge into a plasma such that the positively charged argon ions are attracted to the negatively biased target 38 and sputter target material from it, some of which falls upon the wafer 32 and deposits a layer of the target material on it. In reactive sputtering of tantalum, reactive nitrogen gas is additionally flowed into the chamber 12 from the nitrogen source 18 to react with the tantalum being sputtered to cause the deposition of a tantalum nitride layer on the wafer 32.

The target sputtering rate and sputter ionization fraction can be greatly increased by placing a magnetron 50 in back of the target 38. The magnetron 50 preferably is small, strong, and unbalanced. The smallness and strength increase the ionization ratio and the imbalance projects a magnet field into the processing region for at least two effects of guiding sputtered ions to the wafer and reducing plasma loss to the walls. Such a magnetron includes an inner pole 52 of one magnetic polarity along the central axis 14 and an outer pole 54 which surrounds the inner pole 52 and has the opposite magnetic polarity. The magnetic field extending between the poles 52, 54 in front of the target 38 creates a high-density plasma region 56 adjacent the front face of the target 46, which greatly increases the sputtering rate. The magnetron 50 is unbalanced in the sense that the total magnetic intensity of the outer pole 54, that is, the magnetic flux integrated over its area, is substantially greater than that of the inner pole, for example, by a factor of two or more. The unbalanced magnetic field projects from the target 38 toward the wafer 32 to extend the plasma and to guide sputtered ions to the wafer 32 and reduce plasma diffusion to the sides. The magnetron 50 may be formed in a round, triangular, or arc shape that is asymmetrical about the central axis 14 and in different applications extends substantially from the central axis 14 to the outer limit of the useful area of the target 38 or is concentrated in the peripheral area of the target 38. A motor 60 drives a rotary shaft 62, which extends along the central axis 14 and is fixed to a plate 66 supporting the magnetic poles 52, 54 to rotate the magnetron 40 about the central axis 40 and produce an azimuthally uniform time-averaged magnetic field. If the magnetic poles 52, 54 are formed by respective arrays of opposed cylindrical permanent magnets, the plate 66 is advantageously formed of a magnetic material such as magnetically soft stainless steel to serve as a magnetic yoke.

Additional elements may be added to increase the performance. Auxiliary RF inductive coils and arrays of electromagnet coils have been added to tantalum sputtering chambers. Electrically floating shields and sidewall magnets have been added to copper sputtering chambers. Other shield configurations are possible.

A conventional copper/tantalum liner via structure 60 is illustrated in the cross-sectional view of FIG. 2. A conductive feature 62 is formed in a lower-level dielectric layer 64. An upper-level dielectric layer 66 is deposited over both the conductive feature 62 and the remaining exposed upper surface of the lower-level dielectric layer 64. Silicon dioxide is the conventional dielectric material of both dielectric layers 64, 66 but other low-k materials are being developed, but at the present time they are most usually oxide materials. A via hole 68 is etched through the upper-level dielectric layer 66 to overlie and expose the conductive feature 62. The via hole 68 will serve as a vertical electrical connection between the conductive feature 62 and other conductive features and horizontal interconnects formed in and above the upper-level dielectric layer.

Copper is the currently preferred material for the various electrical connections in advanced integrated circuits. However, copper cannot directly contact the dielectric layer 66. Copper does not adhere well to oxide. Copper also can diffuse into the upper-level dielectric layer 66 and cause it to lose its insulating characteristics and short out the devices being formed. Similarly, oxygen can diffuse from the oxide dielectric into the copper decreasing its electrical conductivity. Accordingly, a Ta/TaN bilayer liner is typically interposed between the oxide and the copper. The bilayer liner includes a barrier layer 70 of TaN and an adhesion layer 72 of Ta. The TaN barrier layer 70 adheres to the oxide layer 66 and provides a good barrier to diffusion and the Ta adhesion layer 74 wets well to both TaN on which it is formed and to the copper formed over it. It is preferred that the TaN and Ta layers 70, 72 coat the sidewalls of the via hole 68 but not coat its bottom because of the high resistivity of TaN and only moderate conductivity of Ta in the current path formed in the via. Both the TaN and Ta layers 70, 72 can be deposited in the magnetron sputter reactor 10 of FIG. 1 having a target 38 with at least a sputtering surface formed of tantalum but atomic layer deposition (ALD) of the TaN layer 70 enables a very thin barrier layer.

The copper metallization is preferably deposited by electrochemical plating (ECP). However, ECP requires a plating electrode and greatly benefits from a nucleating or seed layer of copper. Accordingly, a thin copper seed layer 74 is deposited over the Ta adhesion layer 72. Again, the copper seed layer 74 can be deposited in the magnetron sputter reactor 10 of FIG. 1 having a copper target 38. It is desired that the copper seed layer 72 continuously coat the sidewall of the via hole 68 with a sufficient thickness to provide an electrode and a good conduction path for the ECP process as well as well as to nucleate the ECP copper. As will be discussed later, the copper continuity has become a major issue. It is understood that the copper may be alloyed with less than 10 wt % of alloying elements such as aluminum or magnesium.

Thereafter, ECP fills copper into the remaining portion of the via hole 68 and chemical mechanical polishing (CMP) removes whatever copper remains on top of the structure outside of the via hole 68. Most copper metallization utilizes a dual-damascene structure in which the upper-level dielectric layer 66 is etched to form a vertically differentiated structure having many vertically extending via holes 68 formed in its lower half and having horizontally extending trenches formed in its upper half connecting selected ones of the via holes 68 so as to provide horizontal interconnects as well as horizontal interconnects and horizontally extending contacts for yet further metallization levels or for bonding pads in the uppermost level. The liner bilayer 70, 72 and copper seed layer 74 are generally formed within both the vias and the trenches in a single set of steps and a single ECP step deposits the copper for the vertical vias and the horizontal interconnects in the trenches. The conductive feature 62 in the lower-level dielectric layer 64 may be formed in such a trench in the lower metallization level.

Magnetron sputtering has been successfully applied to depositing the TaN/Ta barrier and the copper seed layer in current generations of integrated circuits. Sidewall coverage is improved by producing a high fraction of ionized sputter particles and applying significant RF bias to the wafer pedestal, which in the presence of a plasma and capacitive coupling of the RF power produces a negative DC self bias. The negative voltage attract the positively charged sputter ions deep within the via hole. However, future generations of integrated circuits will present increasing difficulty as the width of the via hole 68 shrinks below current widths at the 90 nm node toward much smaller widths at the 32 nm node (via widths of 50 nm are forecast for the metal-1 level at the 32 nm node) while the thickness of the dielectric layer 66 remains close to 1 μm. Several problems arise from the increasing aspect ratio of the holes. The three liner layers 60, 72, 74 all need to have sufficient thickness on the via sidewalls to perform their functions, for example, a minimum thickness of 2 or 3 nm, even on the bottom portion of the sidewall. The total thickness of the liner layers begins to fill via hole 68.

Copper sputtering of the seed layer 74 is becoming increasingly difficult since it tends to form overhangs 76 at the top of the via hole 68. The overhangs 76 effectively increase the aspect ratio of the via hole 68 making copper sidewall coverage even more difficult. Even if the overhangs 76 do not close the via hole 68, the restricted aperture at the throat to the via hole 68 may impede electrolyte flow during the ECP. The span of the overhangs 76 can be reduced if the thickness of the seed layer 74 is reduced. However, sidewall coverage is almost always less than unity so that a thinner seed layer 74 may result in the seed copper diffusing into globules 78 leaving sidewall voids 79 between the globules 78. There is some diffusion of the copper up and down the sidewall, but it is insufficient with tantalum wetting layers. The sidewalls voids 79 expose the underlying tantalum, and the exposed portions of the tantalum layer 72 are likely to oxidize to tantalum oxide when the wafer is being transferred to the electroplating apparatus. The oxidization causes two major problems. Copper does not adhere well to tantalum oxide. Even if the copper fill bridges the sidewall voids 79 over the oxide, it may separate from the oxide during extending usage, resulting in a reliability problem. Both oxidation and copper agglomeration degrades copper gap fill. If the sidewall voids 79 are large enough and circumferentially interconnected, they may interrupt the current path for electroplating. Although the tantalum layer 72 is somewhat conducting, if it is oxidized, it is effectively an insulator blocking the electroplating current to its exposed surface as well as to other lower portions of the via hole 68. That is, the oxidized tantalum-based barrier presents a significant problem for electroplating copper and voids are commonly observed in the ECP copper, whether directly from the overhangs 76 or from the discontinuous seed layer 74 at the lower two-thirds or half of the via hole 68.

A known method of reducing the overhangs strongly biases the wafer during the sputter deposition or in a separate argon sputter etching step to create a high negative DC self-bias. The bias accelerates the ions to high energy towards the wafer. The resultant high flux of energetic ions to the wafer, whether argon or sputter ions, preferentially etches the exposed corners. However, the field area on top of the dielectric layer 66 is also etched to reduce the copper thickness in the field area on top of the upper-level dielectric layer 66. A relatively thick copper layer in this region is desired to supply electroplating current from the edge of the wafer to its center. Further, strong wafer biasing is discouraged for advanced devices because of the possible damage to very thin layers from energetic ions.

Tantalum and copper, like most metals, typically form as a polycrystalline material. The polycrystalline morphology of the tantalum layer 72 and that of the copper seed layer 74 cause several potential problems. The tantalum grain boundaries provide a ready path for the diffusion of copper so that the TaN layer 70 alone serves as the barrier. Thermal cycling of the integrated circuit during use causes differential thermal expansion, which is likely to fracture the tantalum layer 72 along its grain boundaries, and the fracture propagates through the TaN barrier layer 70, thereby introducing a reliability problem.

Ruthenium has been suggested to replace both the Ta adhesion layer 72 and the copper seed layer 74. Ruthenium does not readily oxidize and, when it does, it forms conductive ruthenium oxide. Ruthenium adheres to TaN and to copper, and it can serve as both an electroplating electrode and a seed layer. However, ruthenium technology has been difficult to implement. Most attempts involve chemical vapor deposition, which is slow and chemical precursors are not readily available. Sputtering of ruthenium has been suggested and appears viable for the near future. Pure ruthenium forms as a polycrystalline metal although its crystallites are relatively small, apparently below 5 nm in size. Further, ruthenium films tend to be brittle and to fracture in fabrication or use. Accordingly, the reliability and diffusion problems discussed previously for polycrystalline tantalum are likely to also need to be addressed for ruthenium, especially for the 32 nm node and perhaps the 65 nm node. Even if ruthenium is provided as an additional layer on top of the oxidizable tantalum layer 72, its thickness must be minimized in view of the large number of layers already needed in the via hole 68. As a result, a thin ruthenium layer does not of itself provide a complete solution.

Accordingly, a better barrier structure is desired and it further desired that it be formed by sputtering.

### SUMMARY OF THE INVENTION

One aspect of the invention includes a liner structure for copper metallization formed in via hole dielectric, such as an oxide. The liner structure includes a barrier layer such as tantalum nitride deposited on the dielectric. A non-oxidizable refractory noble alloy layer or a refractory noble metal layer that is conducting when oxidized is deposited over the barrier layer.

The refractory noble alloy may be an alloy of ruthenium and tantalum, for example, having an atomic alloying ratio of between 5:95 and 95:5. Other Group VIIIB metals except iron may be substituted for the ruthenium. Other Group IVB, VB, and VIB metals may be substituted for the tantalum. A copper seed layer may be deposited over refractory noble metal for electroplating of copper thereover. However, the refractory noble alloy may itself act as the seed and electroplating layer.

The refractory noble alloy layer may be formed to be amorphous and with substantially no grain boundaries to act as an effective barrier. Alloys of ruthenium and tantalum having atomic alloying fractions between about 35:65 and 65:35 tend to form with an amorphous crystallographic structure under the proper deposition conditions, for example, high ionization fraction produced by high target power or small strong magnetrons. Other amorphous alloys may be used having metal-level electrical conductivity and most crystallites, if any, smaller than 1 nm.

The refractory noble alloy may be deposited by magnetron sputtering or by other method such as chemical vapor deposition.

In a further aspect of the invention, a RuTaN barrier may be deposited on the dielectric layer by reactive sputtering or by chemical vapor deposition, such as atomic layer deposition.

The invention also includes sputtering of the refractory noble alloy layer as a barrier layer and the general sputtering of an alloy of ruthenium and tantalum. The invention also includes a sputtering target having a sputtering surface comprising an alloy of ruthenium and tantalum.

Another aspect of the invention uses the refractory noble alloy layer, especially an alloy of ruthenium and tantalum as the barrier layer adjacent the dielectric. It can be used with a copper seed layer or act itself as the seed layer for copper electroplating.

A noble copper alloy seed layer may be formed of copper and one the Group VIIIB elements except iron. Ruthenium copper is the preferred noble copper alloy. The alloying percentages may be freely chosen, but small copper content below 25 at % is preferred ranging down to 1 at % or even 0.01 at %. The noble copper alloy seed layer may serve as an electroplating electrode, especially for copper.

### BRIEF DESCRIPTION OF THE DRAWINGS

FIG. 1 is a schematic cross-sectional view of a conventional magnetron sputter reactor.

FIG. 2 is a cross-sectional view of a conventional copper/tantalum via structure.

FIG. 3 is a cross-sectional view of via liner structure of one embodiment of the invention including a refractory noble alloy layer.

FIG. 4 is a cross-sectional view of a sputter target used in sputter depositing RuTa.

FIG. 5 is a cross-sectional view of a single-layer liner structure of another embodiment of the invention including the refractory noble alloy layer.

FIG. 6 is a cross-sectional view showing the completed metallization of FIG. 5.

FIG. 7 is a cross-sectional view of a via liner structure of yet another embodiment of the invention including a copper noble alloy layer.

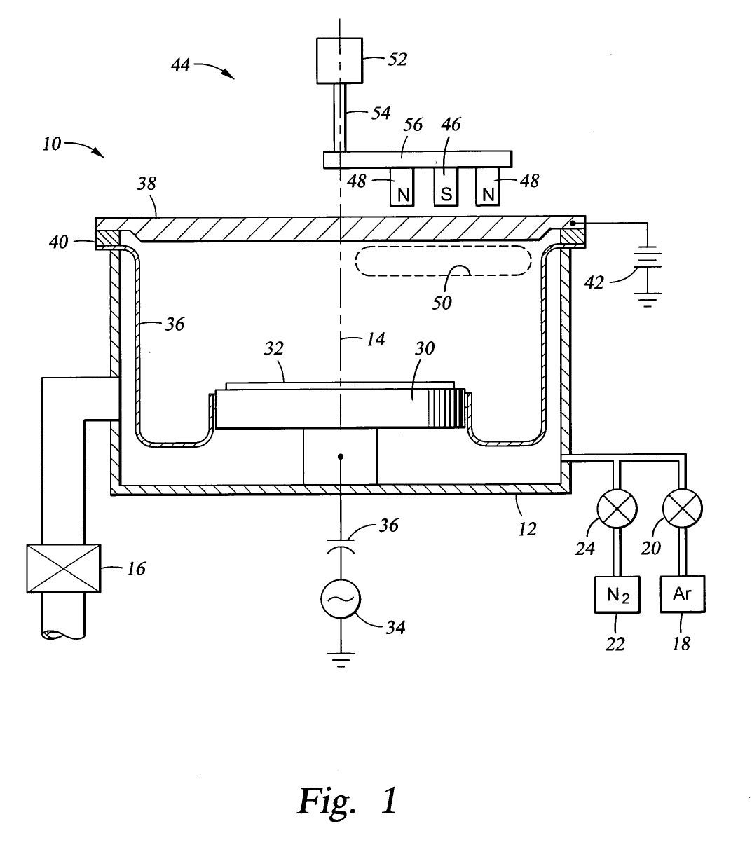

### DETAILED DESCRIPTION OF THE PREFERRED EMBODIMENTS

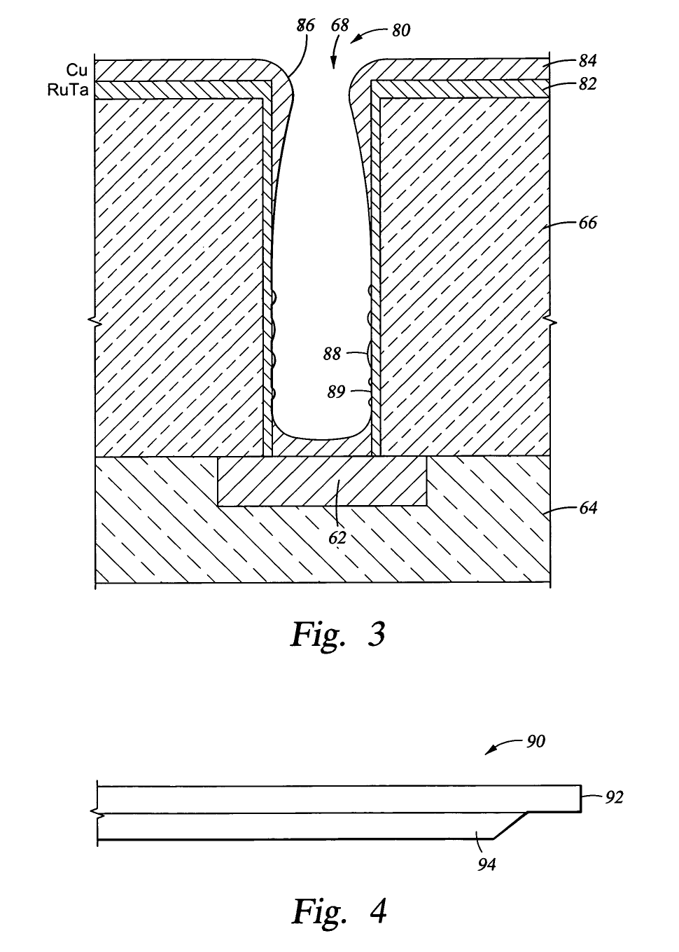

A first embodiment of a novel copper interconnect liner structure 80 is illustrated in the cross-sectional view of FIG. 3. A barrier layer 82 of an alloy of ruthenium and tantalum is deposited directly over the upper-level dielectric layer 66 and onto the sidewalls of the via hole 68. The RuTa alloy is but one type of a refractory noble alloy to be discussed later. A refractory noble alloy is a metal so it is electrically conductive and can be deposited by magnetron sputtering using a target of the desired alloy composition. A copper seed layer 84 is deposited over the RuTa barrier layer 82 to serve as a plating electrode and as a seed for the copper filled into the remaining portion of the via hole 68 by electrochemical plating (ECP). The excess copper deposited above the top of the via hole 68 is thereafter removed by chemical mechanical polishing (CMP).

This structure provides several advantages. The ruthenium content may be sufficiently high that the RuTa alloy does not readily oxidize or at least tends to remain conductive when oxidized because of the conductivity of RuO. As a result, the RuTa alloy layer 82 or other conductive barrier layer underlying the copper seed layer 84 can both act in its exposed portions as an electroplating electrode and further conduct the electroplating current to lower portions of the via hole 68.

The RuTa alloy may form in different crystalline morphologies. In many circumstances, the RuTa alloy forms as a polycrystalline material, which for many aspects of the invention still offers many advantages. However, in one further aspect of the invention, it is possible to sputter deposit a RuTa alloy to form an electrically conductive amorphous metal, also called a glassy metal. That is, the RuTa barrier layer 82 contains substantially no crystallites, at least on the scale of greater than 1 or 2 nm readily observable by electron microscopy, and thus the RuTa barrier layer 82 contains no grain boundaries. An amorphous noble metal alloy has its own further advantages. The substantial lack of grain boundaries means that virtually no diffusion occurs through the amorphous metal alloy layer. The RuTa alloy also adheres well to oxide. As a result of these two effects, no TaN barrier layer is required for an amorphous noble metal alloy layer. Glassy RuTa alloys, like most glassy metals, do not readily oxidize. The amorphous morphology of the RuTa barrier layer 82 also reduces or eliminates many of the failure mechanisms involving grain boundaries. The amorphous RuTa is somewhat plastic under stress and does not concentrate stress at the grain boundaries. Glassy metals have been widely used in the past, for example, as refractory coatings plasma sprayed onto jet engine turbines. Their use in the semiconductor industry appears to be new.

Because the electrical conductivity of amorphous 50:50 RuTa approximates that of β-phase tantalum, it is not necessary to remove the barrier layer from the bottom of the via hole 60. Barrier resistivity decreases with increasing Ru/Ta fraction. However, the bottom may optionally be removed.

Increased ionization fractions of the RuTa sputter atoms in the presence of strong wafer biasing increases the tendency of given refractory noble composition to form in the amorphous state. The ionization fraction is increased by high target power, a small and strong magnetron. Increasing the magnetic intensity in the LDR magnetron, described by Gung et al. in U.S. patent application Ser. No. 10/949,735 filed 23 Sep. 2004, changes the crystalline structure of the deposited film from polycrystalline to amorphous. The sputtering may be performed in various types of sputtering reactors. One type is the EnCoRe II Ta(N) chamber available from Applied Materials, Inc. of Santa Clara, Calif. and described by Gung et al. in U.S. patent application Ser. No. 10/950,349, filed Ser. No. 10/950,349, filed 23 Sep. 2004 and in U.S. patent application Ser. No. ______, filed 29 Apr. 2005 and entitled MULTI-STEP PROCESS FOR FORMING A METAL BARRIER IN A SPUTTER REACTOR. All three applications are incorporated herein by reference.

However, polycrystalline RuTa also offers many advantages over the prior art.

The refractory noble alloys such as RuTa, whether polycrystalline or amorphous, present several advantages. Refractory ruthenium alloys, whether amorphous or polycrystalline, exhibit less stress than pure ruthenium, thus increasing the long and short time reliability. Copper adheres well to ruthenium, tantalum, or RuTa, allowing the copper seed layer 84 to be sputter deposited directly over the RuTa barrier layer 82. As discussed previously, RuTa with a high Ru content, whether polycrystalline or amorphous, does not readily oxidize and, when it does, it retains a relatively high electrical conductivity. The reduced oxidation provides more reliable wetting and bonding to the copper. The high wetting of copper to ruthenium and its alloys produces the advantage that copper tends not to agglomerate on the RuTa so that a thinner copper seed may be deposited while still remaining continuous on the via sidewall. The higher tantalum percentages are disadvantageous because of the tendency of tantalum to oxidize. However, if the oxidation problem is accounted for by other means, such as guaranteeing a continuous copper seed layer, even the low ruthenium content has been observed to promote copper hole filling, presumably because of the increased wetting promotes copper diffusion on the via sidewall. Generally, hole filling improves with increasing ruthenium fraction, all the way to 100% ruthenium, which however has its own disadvantages. Furthermore, the reduced oxidation and conductivity of ruthenium oxide allows the RuTa alloy layer to provide dependable conductive paths for the plating current if the copper is interrupted. As a result, the copper coverage need not be complete. A copper matrix pattern with holes therethrough is satisfactory as long as the matrix has sufficient density to nucleate the ECP copper. Even if the copper agglomerates in deposition or further processing, the exposed non-oxidized or at least conductive RuTa layer provides both vertical and horizontal conduction paths for the electroplating current.

Copper overhangs 86 may still form but, because of the thinner seed layer 84, they are less likely to significantly close the throat of the via hole 68. Further, the increased sidewall diffusion of copper over a ruthenium-based layer may draw the overhang material into the via hole, thus decreasing the extent of the overhand. Accordingly, the more aggressive means to prevent overhangs or to etch them can be avoided. Even if the thin copper seed layer 84 diffuses to form agglomerations 88 with sidewall voids 89 exposing the Ru-based layer 82, the sidewall voids 89 expose a generally non-oxidizable or at least conductive barrier, such as RuTa. However, agglomerations 88 and voids 89 are reduced because of the better wetting of the Ru-based layer 82. The barrier provides an electroplating electrode as well as an electroplating lower portions of the via hole 68. The sputter etching of copper allows a significantly thicker copper layer in the field region, thus promoting the flow of electroplating current from the edges of the wafer.

The alloying percentages for a RuTa barrier or similar barrier may vary between 5:95 and 95:5 in atomic percentages for ruthenium and tantalum respectively. It is believed that the amorphicity is promoted by near equal atomic percentages, that is, a 50:50 RuTa alloy. But even 5 at % of ruthenium is sometimes advantageous. However, ruthenium is expensive and brittle and so subject to fraction. On the other hand, tantalum oxidizes so that the extreme percentages are not preferred. A ruthenium fraction of 80 at % or even 70 at % has been observed in some experiments to form as small crystallites though careful process tuning of sputtering ionization fraction and wafer biasing may allow 80:20 RuTa be made to deposit in an amorphous phase. However, 57 at % of ruthenium has been observed to form as a glassy film under the proper conditions. Accordingly, 20:80 and 80:20 RuTa alloys may represent desired alloying limits for an amorphous layer and the same range promises good results with polycrystalline RuTa with good oxidation resistance. However, higher ruthenium fractions than 80 at % may be desired to prevent any oxidation.

The thickness of the RuTa layer deposited on the wafer may be freely chosen. However, a preferred thickness range is 10 to 15 nm, as measured in the field region on planar top of the dielectric, although encouraging tests have been done down to 7 nm. RuTa thicknesses are contemplated down to 1 nm but thicknesses of 5 to 15 nm are a current preferred range. Sidewall coverage under proper sputtering conditions has been observed at between 10 and 20%. The copper seed layer may have a thickness in the field region of about 30 nm although it is anticipated that this thickness can be reduced.

In verification tests, several such liner structures have been sputter deposited. The RuTa alloy may be co-sputtered from a target composed of tantalum areas and ruthenium areas. However, a uniform RuTa target is desired. But, ruthenium and tantalum are immiscible in each other. Nonetheless, a RuTa target 90 illustrated in partial cross-section in FIG. 4 may be formed by sintering together a mixture of pure ruthenium powder and pure tantalum powder in a proportion corresponding to the desired RuTa alloying percentage. The mixed powders and a sintering agent are filled into a sintering mold. The mold is processed at high temperature and optionally at high pressure to form a free-standing target disk 94 of RuTa with edge bevels shaped in correspondence to the shield 36 with a plasma dark space between them. The sintering process is well known in the target industry. Typically, indium is used to bond the resultant target disk 94 to a backing plate 92, for example, composed of brass. Part of the backing plate 92 is left uncovered to serve as a flange for mounting the target 90 on the sputtering chamber.

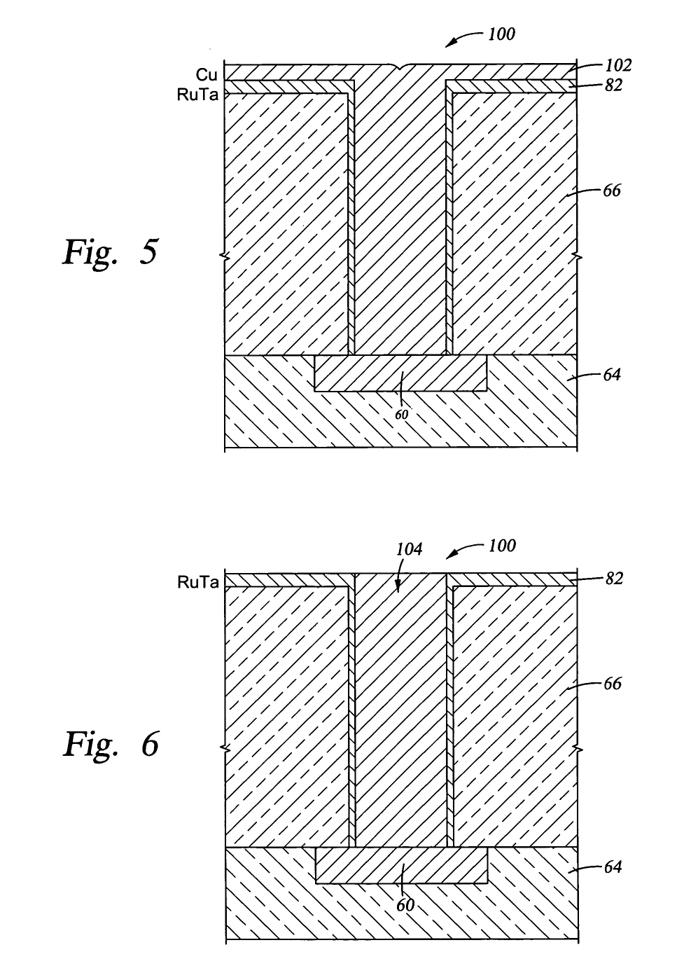

The RuTa layer 82, particularly when formed as an amorphous metal, allows the elimination of the copper seed layer. A copper metallization structure 100 illustrated in the cross-sectional view of FIG. 5 includes only the RuTa layer 82 between the dielectric layer 66 and an copper fill layer 102 deposited by ECP. The RuTa layer 82 serves as a barrier layer, an adhesion layer, and an ECP electrode. The ready adhesion between copper and RuTa indicates that it will provide adequate nucleation of the ECP copper 102. After the ECP, CMP removes the ECP layer 102 exposed outside of the via hole. The CMP process may be tuned to either leave or remove the fairly hard RuTa layer 82 in the field region on top of the dielectric layer 66. It is to be appreciated that dual-damascene may result in a combination of a lower via and an upper trench connected to the via being filled by the liner and the ECP copper.

The RuTa alloy has the advantage that tantalum is widely used in the semiconductor industry and the use of ruthenium has been intensively investigated. However, other refractory noble alloys can be used to similar effect. Other near noble or platinum-group metals in Group VIIIB in the periodic table excluding iron may be substituted for all or part of the ruthenium, that is, Co, Ni, Rh, Pd, Os, Ir, and Pt, although several of these are scarce and expensive. A refractory metal chosen from Groups IVB, VB, and VIB of the periodic table, such as titanium (Ti), molybdenum (Mo), or tungsten (W), may be substituted for all or part of the tantalum. Ternary and higher-component refractory noble alloys are included within the invention and yet other elements may be included within the refractory noble alloy of the invention.

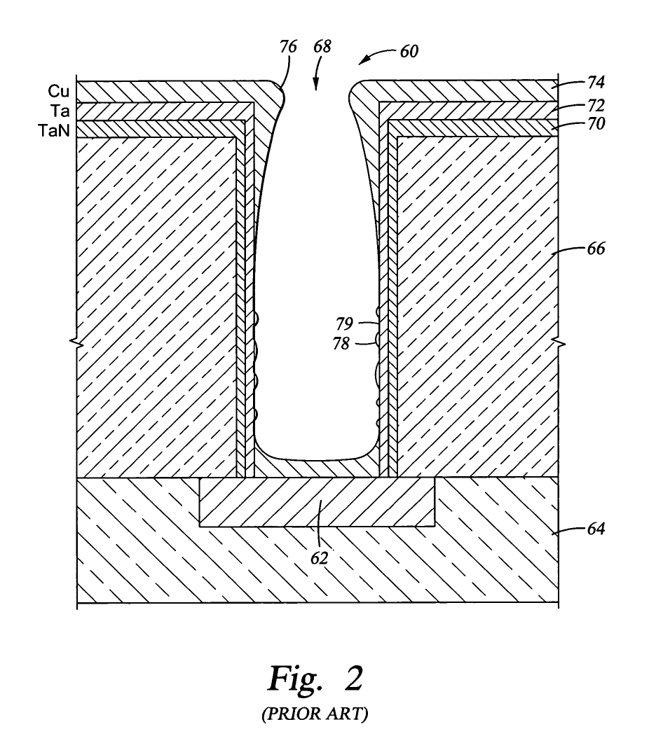

Another embodiment of the invention includes a barrier layer of a RuTa nitride, for example, coated on the dielectric layer, by either reactive sputtering of RuTa in the presence of nitrogen or by CVD, especially atomic layer deposition since it allows very thin barriers. The RuTaN layer may replace the TaN layer 70 in the conventional structure of FIG. 2 or underlie the RuTa layer 82 of FIGS. 3, 5, or 6. The RuTaN alloy acts as a diffusion barrier but adheres well to the dielectric.

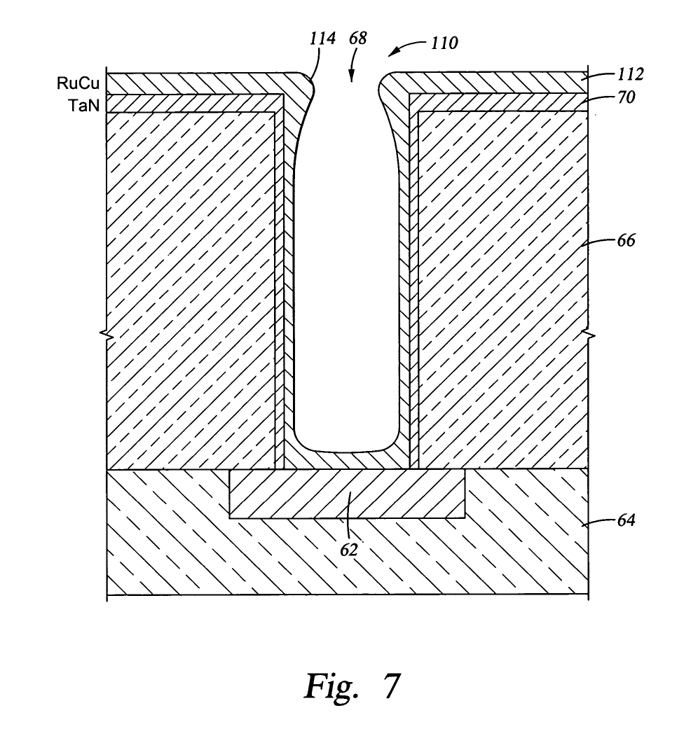

Another Ru-based layer is illustrated in the cross-sectional view of FIG. 7. A liner structure 110 is formed in the previously described via hole 68. It includes the barrier layer 70, such as a conventional TaN layer deposited either by atomic layer deposition (ALD) or sputtering to be very thin, for example, 2 nm or less in thickness. An noble copper alloy seed layer 112 is deposited over the barrier layer 70, preferably by sputtering. The noble copper alloy seed layer 112 may be composed of a RuCu alloy or an alloy of copper with the platinum-group elements mentioned above. Other constituents may be included in the noble copper alloy as long as the alloy remains a conductive metal. Preferably also, the copper content is low, preferably less than 25 at %, more preferably less than 10 at % but possible lower limits are 1 at % and 0.01 at. On the other hand, a high ruthenium content of at least 50 at % provides good oxidation resistance but the invention may be extended down to ruthenium content of 1 at %. Since the RuCu alloy is conductive, there is little need to remove it from the bottom of the via hole. Ruthenium and copper are nearly immiscible with each other so that they tend to segregate during any warm temperature processing or operation. The segregation has the advantage that copper islands may form on the surface of the alloy seed layer 112 and serve as nucleation and bonding sites for an ECP copper layer filled into the via hole 68 directly over the alloy seed layer 112. No separate copper seed layer is required, but it may be included if desired. On the other hand, the segregated ruthenium acts as a further barrier and non-oxidizable or at least conducting plating electrode and plating current path.

A RuCu or related noble copper alloy sputtering target can be formed, for example, following the procedure described for the RuTa target. The RuCu alloy has the advantage of the developed technology for both of these materials The sputter deposition of RuTa or RuCu or other ruthenium metal alloy is advantageously fast and easily implemented. However, RuTa or RuCu deposited by CVD or other method has similar advantageous material properties.

Although the illustrated via structures include few layers, other intermediary layers may be formed between the refractory noble alloy layer or the copper noble alloy layer and the dielectric and the copper fill. Although the invention is primarily directed to liners for copper metalllization, the described alloy layers may be applied to other uses and other metallizations.

The invention provides a substantially improved performance and greater simplicity over the prior art liner structures and their fabrication methods with only a slight change of the already well developed sputtering technology.

1. A method of forming a liner structure for a copper metallization, comprising:
providing a substrate having a hole formed in a dielectric layer;
forming a refractory noble alloy layer over said dielectric layer including sidewalls of said hole, said refractory noble alloy layer comprising an alloy of at least 5 at % of a refractory metal chosen from Groups IVB, VB, and VIB of the periodic table and at least 5 at % of a platinum-group metal chosen from Group VIIIB of the periodic table except iron

2. The method of claim 1, wherein said refractory metal comprises tantalum and said platinum-group metal comprises ruthenium.

3. The method of claim 2, wherein said refractory noble alloy layer comprises 40 to 80 at % ruthenium and 40 to 60 at % tantalum.

4. The method of claim 1, further comprising sputter depositing a seed layer of copper over said refractory noble alloy layer.

5. The method of claim 4, further comprising filling copper into said hole over said seed layer by electrochemical plating.

6. The method of claim 1, further comprising filling copper into said hole directly onto said refractory noble alloy layer.

7. The method of claim 1, wherein said refractory noble alloy layer additionally comprises nitrogen.

8. The method of claim 1, wherein said forming step comprises sputtering.

9. The substrate including the liner structure formed by the method of claim 1.

10. A method of forming a metallization in a semiconductor structure, comprising the steps of:
providing a substrate having a hole formed in a dielectric layer;
depositing a liner layer comprising a conductive amorphous metal over said dielectric layer including sidewalls of said hole; and
filling copper into said hole over said liner layer.

11. The method of claim 10, wherein said amorphous metal comprises a refractory noble alloy of a refractory metal chosen from Groups IVB, VB, and VIB of the periodic table and a platinum-group metal chosen from Group VIIIB of the periodic table except iron.

12. The method of claim 11, wherein said refractory metal is chosen from tantalum, titanium, tungsten, and molybdenum.

13. The method of claim 12, wherein the platinum-group metal comprises ruthenium.

14. The method of claim 11, wherein the platinum-group metal comprises ruthenium.

15. The method of claim 14, wherein said refractory metal comprises tantalum.

16. The method of claim, wherein said amorphous metal is deposited by sputtering.

17. The method of claim 10, further comprising sputter depositing a copper layer over said liner layer and said filling step fills said copper over said copper layer.

18. A target configured to be mounted on a plasma sputter reactor, comprising:
a backing plate mountable on said reactor; and
a surface layer bonded to said backing plate and comprising an alloy comprising at least 5 at % of a refractory metal chosen from Groups IVB, VB, and VIB of the periodic table and at least 5 at % of a platinum-group metal chosen from Group VIIIB of the periodic table except iron.

19. The target of claim 18, wherein said refractory metal comprises tantalum and said platinum-group metal comprises ruthenium.

20. The target of claim 19, wherein said alloy comprises between 40 and 95 at % of ruthenium and no more than 60 at % of tantalum.

21. A method of sputtering, comprising:
exciting a plasma in a chamber to thereby sputter a target comprising at least 5 at % of a refractory metal chosen from Groups IVB, VB, and VIB of the periodic table and of a platinum-group metal chosen from Group VIIIB of the periodic table except iron to deposit material of said target onto a workpiece.

22. The method of claim 21, wherein said refractory metal is tantalum and said platinum-group metal is ruthenium.

23. The method of claim 21, further comprising admitting nitrogen into said chamber to perform reactive sputtering including forming a nitride layer.

24. An interconnect structure, comprising:
a lower level including a conductive feature formed in a lower dielectric layer;
an upper level including an interconnect hole form in an upper dielectric layer overlying said conductive feature; and
a liner formed on at least sidewalls of said hole comprising at least 5 at % of a refractory metal chosen from Groups IVB, VB, and VIB of the periodic table and of a platinum-group metal chosen from Group VIIIB of the periodic table except iron.

25. The structure of claim 24, wherein said refractory metal comprises tantalum and said platinum-group metal comprises ruthenium.

26. The structure of claim 24, wherein said liner is amorphous.

27. The structure of claim 26, wherein said amorphous liner directly contacts said upper dielectric layer.

28. The structure of claim 24, wherein said liner additionally comprises nitrogen to form a nitrided liner layer.

29. A method of forming a liner structure for a copper metallization, comprising:
providing a substrate having a hole formed in a dielectric layer overlying a conductive feature;
depositing a barrier layer on at least sidewalls of said hole; and
depositing an alloy seed layer over said barrier layer including sidewalls of said hole, said alloy seed layer comprising between 1 and 25 at % of copper and at least 50 at % of a platinum-group metal chosen from Group VIIIB of the periodic table except iron.

30. The method of claim 29, wherein said platinum-group metal comprises ruthenium.

31. The method of claim 29, wherein said barrier comprises TaN.

32. The method of claim 29, wherein said alloy seed layer is deposited by sputtering.

33. The substrate including the liner structure produced by the process of claim 29.
